(19) United States
(12) Patent Application Publication
(10) Pub. No.: US 2026/0266963 A1
(43) Pub. Date: Sep. 10, 2026

(54) RECONFIGURABLE SINGLE-PHOTON AVALANCHE DIODE SENSORS WITH COLUMN-LEVEL TIMECODE DISTRIBUTION

(71) Applicant: OMNIVISION TECHNOLOGIES, INC., Santa Clara, CA (US)

(72) Inventor: Andreas Suess, San Jose, CA (US)

(21) Appl. No.: 19/071,646

(22) Filed: Mar. 5, 2025

(51) Int. Cl. G01S 7/481; G01S 7/4865; G01S 7/497; G01S 17/894

(52) U.S. Cl. CPC G01S 7/4816; G01S 7/4865; G01S 7/497; G01S 17/894

(57) ABSTRACT

Reconfigurable single-photon avalanche diode (SPAD) sensors with column-level timecode distribution (and associated systems, devices, and methods) are disclosed herein. In one embodiment, an imaging system includes a pixel array including a plurality of SPAD sensors arranged in a plurality of rows and columns, and a plurality of timers. Each timer corresponds to a respective column and can generate timecodes based on a clock signal. Each SPAD sensor of a given column can receive the timecodes generated by the timer corresponding to the given column. The system can include calibration circuitry configured to sample skew along one or more columns of the pixel array, and a clock distribution network to distribute the clock signal to the timers and the calibration circuitry.

### TECHNICAL FIELD

This disclosure relates generally to image sensors, such as image sensors that are configured to make time-of-flight (ToF) calculations. For example, several embodiments of the present technology described in detail below relate to image sensors (and associated systems, devices, and methods) with column-based time-to-digital conversion architectures and associated calibration circuitry.

### BACKGROUND

Image sensors have become ubiquitous and are now widely used in digital cameras, cellular phones, security cameras, as well as medical, automobile, and other applications. As image sensors are integrated into a broader range of electronic devices, it is desirable to enhance their functionality, performance metrics, and the like in as many ways as possible (e.g., resolution, power consumption, dynamic range, etc.) through both device architecture design as well as image acquisition processing.

Image sensors operate in response to image light coming from an external scene that is incident upon the image sensor. An image sensor includes an array of pixels having photosensitive elements (e.g., photosensors, photodiodes) that absorb a portion of the incident image light and, in response, generate corresponding electrical charge. The electrical charge of individual pixels may be measured as an output voltage of each photosensitive element. In general, the output voltage varies as a function of the intensity and duration of the incident light. The output voltage of individual photosensitive elements can be used to produce a digital image (e.g., image data) representing the external scene.

In some applications, photodiodes (e.g., single-photon avalanche diodes) may be used to perform time-of-flight (ToF) calculations. This may be accomplished, for example, by counting photodiode trigger events, storing the counts in corresponding bins of a histogram, and detecting and using a peak of the histogram to perform depth calculations.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure. The drawings should not be taken to limit the disclosure to the specific embodiments shown, but are provided for explanation and understanding.

FIG. 1 is a partially schematic diagram illustrating a time-of-flight (ToF) imaging system in an example environment, the ToF imaging system configured in accordance with various embodiments of the present technology.

FIG. 2 is a partially schematic, functional block diagram illustrating a reconfigurable single-photon avalanche diode (SPAD) sensor that can transition between operating in a depth mode and operating in an intensity mode and that is configured in accordance with various embodiments of the present technology.

FIG. 3 is a partially schematic, functional block diagram illustrating a time-of-flight (ToF) imaging system configured in accordance with various embodiments of the present technology.

FIG. 4 is a flow diagram illustrating a method of operating a reconfigurable SPAD sensor with column level timecode distribution in accordance with various embodiments of the present technology.

Skilled artisans will appreciate that elements in the figures are illustrated for simplicity and clarity and are not necessarily drawn to scale. For example, the dimensions of some of the elements in the figures may be exaggerated relative to other elements to aid in understanding of various aspects of the present technology. In addition, common but well-understood elements or methods that are useful or necessary in a commercially feasible embodiment are often not depicted in the figures, or described in detail below, to avoid unnecessarily obscuring the description of various aspects of the present technology.

### DETAILED DESCRIPTION

As described in greater detail below, the technology disclosed herein relates to image sensors, such as reconfigurable SPAD sensors that can detect and process light for 3D imaging. The image sensors can include pixel arrays and associated timing circuitry with column-based time-to-digital conversion (TDC) architectures. In some embodiments, each column of pixels in the pixel array can include its own timecode generator, with timecodes generated by each timecode generator shared amongst reconfigurable SPAD sensors of the column. Such a timing circuitry architecture is expected to save space and power in comparison to using a unique instance of a timecode generator for each reconfigurable SPAD sensor of the array and/or in comparison to using a single global timecode generator that is configured to propagate timecodes to every reconfigurable SPAD sensor of the array. To ensure accurate timing across each column of reconfigurable SPAD sensors, image sensors of the present technology can additionally include calibration circuits that are configured to correct for any skew or timing differences caused, for example, by temperature or voltage gradients.

In the following description, specific details are set forth to provide a thorough understanding of aspects of the present technology. One skilled in the relevant art will recognize, however, that the systems, devices, and techniques described herein can be practiced without one or more of the specific details set forth herein, or with other methods, components, materials, etc.

Reference throughout this specification to an “example” or an “embodiment” means that a particular feature, structure, or characteristic described in connection with the example or embodiment is included in at least one example or embodiment of the present technology. Thus, use of the phrases “for example,” “as an example,” or “an embodiment” herein are not necessarily all referring to the same example or embodiment and are not necessarily limited to the specific example or embodiment discussed. Furthermore, features, structures, or characteristics of the present technology described herein may be combined in any suitable manner to provide further examples or embodiments of the present technology.

Spatially relative terms (e.g., “beneath,” “below,” “over,” “under,” “above,” “upper,” “top,” “bottom,” “left,” “right,” “center,” “middle,” and the like) may be used herein for ease of description to describe one element's or feature's relationship relative to one or more other elements or features as illustrated in the figures. It will be understood that the spatially relative terms are intended to encompass different orientations of a device or system in use or operation, in addition to the orientation depicted in the figures. For example, if a device or system illustrated in the figures is rotated, turned, or flipped about a horizontal axis, elements or features described as “below” or “beneath” or “under” one or more other elements or features may then be oriented “above” the one or more other elements or features. Thus, the exemplary terms “below” and “under” are non-limiting and can encompass both an orientation of above and below. The device or system may additionally, or alternatively, be otherwise oriented (e.g., rotated ninety degrees about a vertical axis, or at other orientations) than illustrated in the figures, and the spatially relative descriptors used herein are interpreted accordingly. In addition, it will also be understood that when an element is referred to as being “between” two other elements, it can be the only element between the two other elements, or one or more intervening elements may also be present.

Temporal relative terms such as “simultaneously,” “substantially simultaneously,” or “at the same time” are used herein to describe simultaneous performance or operation occurrence in a near instantaneous manner that takes into account necessary delays in signal transmission and/or processing, such as circuitry processing time, signal propagation time, computing time, or the like associated with circuit components. Thus, unless otherwise specified, “simultaneously,” “substantially simultaneously,” or “at the same time” as used herein may refer to events or operations that occur at the exact same time or within one second or less of each other after taking into account signal transmission and/or processing.

It will be understood that, although the terms first, second, third, etc., may be used in the disclosure and claims to describe various elements, these elements should not be limited by these terms and should not be used to determine the process sequence or formation order of associated elements. Unless otherwise indicated, these terms are merely used to distinguish one element from another element. Thus, a first element discussed below could be termed a second element without departing from the teachings of the disclosed embodiments. As another example, an element can be termed a “third element” to distinguish the element (e.g., for antecedent-basis purposes) from another element termed a “first element,” and without requiring the presence of a second element.

It is appreciated that the term “semiconductor material” recited throughout the disclosure may correspond to a part of or an entirety of a semiconductor wafer (e.g., a silicon wafer). In some embodiments, the semiconductor material may include or otherwise formed of silicon, a silicon germanium alloy, germanium, a silicon carbide alloy, an indium gallium arsenide alloy, any other alloys formed of III-V group compounds, combinations thereof, one or more epitaxial layers of the aforementioned materials, or a bulk substrate thereof. More specifically, semiconductor material may correspond to any semiconductor material or combination of materials that may be doped or otherwise configured to facilitate the formation of an integrated circuit (e.g., forming individual circuitry components such as source/drain regions of transistors, memory elements, photodiodes, or the like). It is appreciated that the term “photodiode” may correspond to a doped region disposed within the semiconductor material configured to photo generate image charge(s) (e.g., one or more electrons or holes) in response to incident light. For example, photodiode may correspond to an n-doped region disposed within a p-type semiconductor material or an n-doped region surrounded by a p-type well disposed within the semiconductor material.

Throughout this specification, several terms of art are used. These terms are to take on their ordinary meaning in the art from which they come, unless specifically defined herein or the context of their use would clearly suggest otherwise. It should be noted that element names and symbols may be used interchangeably through this document (e.g., Si vs. silicon); however, both have identical meaning.

### A. OVERVIEW

Many existing SPAD sensor designs face difficulties in efficiently generating and distributing accurate timing information across the pixel array. Generating timing codes (“timecodes”) locally in each pixel consumes significant area and power. Moving timing generation off-pixel, however, introduces skew across pixels that can degrade timing accuracy. Additionally, temperature and voltage variations across large pixel arrays can lead to systematic timing errors that are challenging to compensate for using many designs. Balancing the tradeoffs between timing accuracy, power consumption, and pixel area utilization remains an ongoing challenge for high-performance SPAD imaging systems.

To address at least some of these challenges, the present technology is generally directed to column-based TDC architectures with efficient timing generation and distribution. In one embodiment, an imaging system can include multiple columns of reconfigurable SPAD sensors (also referred to herein as “pixels”), with each column assigned its own timecode generator. Such a configuration is expected to free up pixel area and reduce power consumption in comparison to configurations that implement pixel-level timing generation. In some embodiments, the imaging system of the present technology employs an H-tree distribution of a clock signal across the columns to minimize skew and ensure synchronization. In these and other embodiments, the imaging system can include calibration circuits that are usable to (i) address skew that may be introduced at the column level and/or (ii) compensate for temperature or voltage variations. As a specific example, the imaging system can include calibration circuits that are configured to sample skew along columns of a clock tree using a skew-free clock signal, with samples taken repetitively and averaged across histogram windows.

Systems configured in accordance with the present technology are expected to provide several advantages, especially in comparison to other designs. For example, by moving timecode generation to the column level, systems configured in accordance with the present technology are enabled to each use a single clock signal and distribute it to multiple columns of pixels using a single clock tree. In addition, column-based TDC architectures of the present technology allow for scalability while maintaining timing accuracy across the entire imaging system or pixel array. Furthermore, implementation of calibration circuits into such systems is expected to compensate for skew and systematic timing errors caused by temperature and voltage variations, addressing key challenges in large sensor arrays. As a result, by utilizing column-level timecode generation and calibration circuitry, systems of the present technology are expected to achieve a balance between timing accuracy, power consumption, and pixel area utilization, while maintaining scalability. By contrast, many other systems require multiple clock signals and multiple clock trees to propagate timecodes to multiple columns of pixels, which are architectures that (a) consume a relatively large amount of power, (b) utilize a relatively large amount of pixel area, and (c) have poor scalability. In addition, such other systems typically do not include calibration circuitry, meaning that such other systems are typically unable to account for skew and/or systematic timing errors caused by temperature and voltage variations.

### B. SELECTED EMBODIMENTS OF RECONFIGURABLE SPAD SENSORS WITH COLUMN-LEVEL TIMECODE DISTRIBUTION, AND ASSOCIATED SYSTEMS, DEVICES, AND METHODS

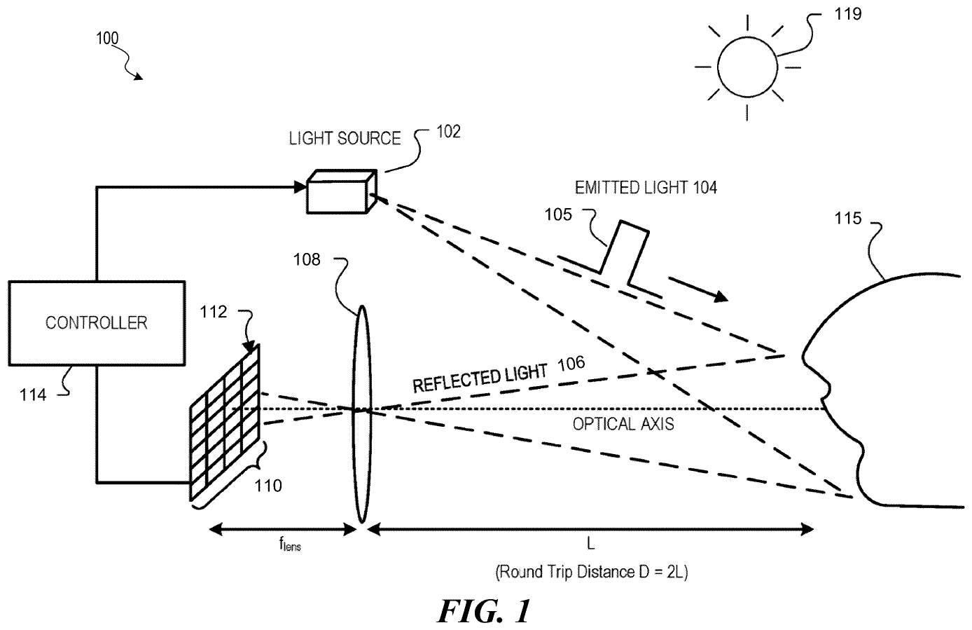

FIG. 1 is a partially schematic diagram illustrating a time-of-flight (ToF) imaging system 100 (“the system 100”) configured in accordance with various embodiments of the present technology. As shown, the system 100 includes a light source 102, a lens 108, a pixel array 110 including a plurality of photomultiplier pixel cells 112, and a controller 114. The controller 114 is configured to control (e.g., synchronize) operation of the light source 102 and the plurality of photomultiplier pixel cells 112 included in pixel array 110. In addition, the controller 114 can be coupled to the pixel array 110 to receive and process information readout from the photomultiplier pixel cells 112.

In the illustrated embodiment, the pixel array 110 is positioned at a focal length fₗₑₙₛ from the lens 108. In this example, the light source 102 and the lens 108 are positioned at a distance L from an object 115. It is appreciated that FIG. 1 is not illustrated to scale and that, in at least one example, the focal length fₗₑₙₛ is substantially less than the distance L between the lens 108 and the object 115. Therefore, it is appreciated that the distance L and the distance L+ focal length fₗₑₙₛ can be substantially equal for the purposes of time-of-flight measurements obtained in accordance with the teachings of the present technology. As illustrated, the pixel array 110 and the controller 114 are represented as separate components for explanation purposes. It is appreciated, however, that the pixel array 110 and the controller 114 can be integrated into a same image sensor, such as a stacked chip sensor or a planar sensor.

Furthermore, it is appreciated that the pixel array 110 shown in FIG. 1 is illustrated as a two-dimensional (2D) array of photomultiplier pixel cells 112 arranged into a plurality of rows and a plurality of columns. As such, it is appreciated that the 2D pixel array 110 can be suitable for acquiring a three-dimensional (3D) image of the object 115 and/or other objects within an external scene. In another example, it is appreciated that the pixel array 110 can also be implemented as a one-dimensional array of photomultiplier pixel cells 112, which can be useful in line scan sensor applications (or the like), in accordance with various teachings of the present technology. Furthermore, in yet another example, it is appreciated that when the pixel array 110 is incorporated in light sensing systems that do not require time-of-flight measurements, the light source 102 can be omitted.

Referring again to the embodiment illustrated in FIG. 1, the system 100 can be configured as a 3D camera that calculates depth information related to distances between the system 100 and objects (e.g., the object 115) within an imaged external scene that are positioned within a field of view (FOV) of the system 100. The depth information can be based on time-of-flight measurements conducted using the light source 102, the pixel array 110, and the controller 114. The system 100 can operate in conditions with bright ambient light 119 (e.g., outside mid-day), and each photomultiplier pixel cell 112 in the pixel array 110 can determine depth information for a corresponding portion of the FOV such that a 3D image of objects (e.g., the object 115) in the external scene can be generated.

More specifically, depth information related to the object 115 can be determined by measuring a round-trip time (RTT) for light, emitted from the light source 102, to propagate from the light source 102 to the object 115 and back to the system 100. For example, referring to the illustrated embodiment, the light source 102 (e.g., a vertical-cavity surface-emitting laser) can be configured to emit light 104 (including light pulses 105) toward the object 115 over the distance L. At least some of the emitted light 104 can then be reflected off the object 115 as reflected light 106, some of which propagates towards the system 100 over the distance L, is focused onto the pixel array 110 by the lens 108, and is incident upon one or more photomultiplier pixel cells 112 of the pixel array 110 as image light. Each photomultiplier pixel cell 112 in the pixel array 110 can include one or more photon detectors (e.g., photosensors, photodiodes, etc., such as one or more SPADs) to detect the image light and convert the image light into an electrical output signal (e.g., image charge).

As shown in the depicted example, the round-trip time for light pulses 105 of the emitted light 104 can be used to determine the distance L (representing the distance between the object 115 and the lens 108/pixel array 110) using the following relationships in Equations (1) and (2) below in which c is the speed of light (e.g., approximately equal to 3×10⁸ m/s) and TTOF is the round-trip time that represents an amount of time it takes for a light pulse 105 of light 104 emitted from the light source 102 to travel to and from an object in an external scene:

$${T}_{TOF} = \frac{2 L}{c} \qquad ( 1 )$$

$$L = \frac{{T}_{TOF} * c}{2} \qquad ( 2 )$$

Accordingly, once the round-trip time is determined using the system 100 and thereby becomes a known variable, the distance L can be calculated and subsequently used to determine depth information for the object 115 (e.g. how far away the object 115 is positioned from the system 100).

As discussed above and as shown in the illustrated embodiment, the controller 114 is configured to control the pixel array 110 (including the photomultiplier pixel cells 112) and the light source 102. In some embodiments, the controller 114 includes logic that, when executed, causes the system 100 to perform operations for determining the round-trip time, which can be based at least in part on timing signals generated and/or used by a time-to-digital converter. The timing signals can be representative of (a) when the light source 102 emits pulses 105 of emitted light 104 and (b) when the photomultiplier pixel cells 112 detect image light (e.g., as part of the reflected light 106). In these and other embodiments, the controller 114 can include various control circuitry for operating the system 100. As a specific example, the controller 114 can include row control circuitry that can be used to externally provide row addresses to reconfigurable SPAD sensors for accessing data stored to corresponding rows of in-pixel SRAMs (as described in greater detail below).

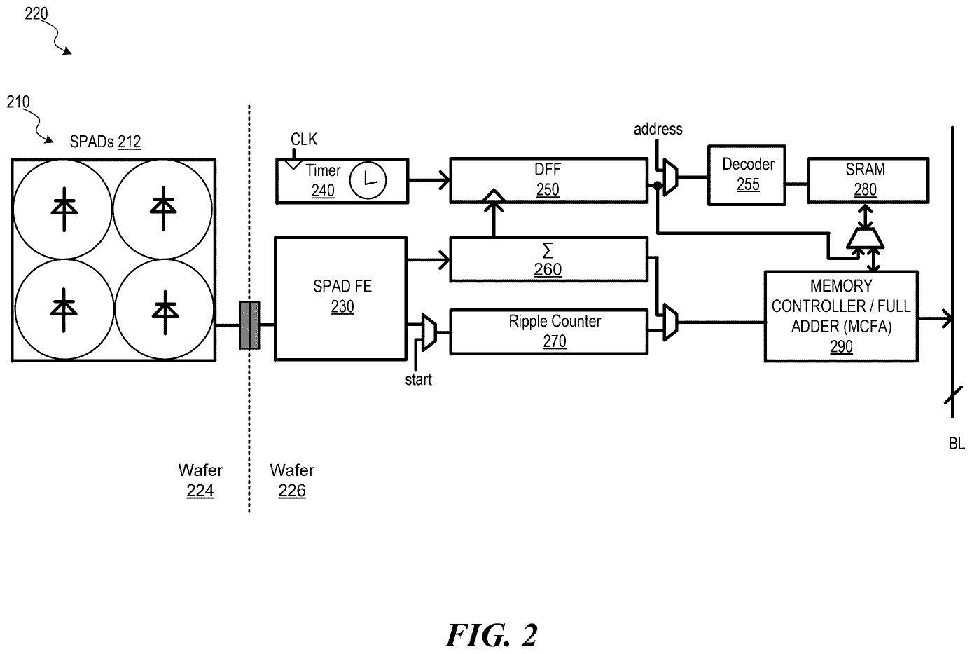

FIG. 2 is a partially schematic, functional block diagram illustrating a reconfigurable single-photon avalanche diode (SPAD) sensor 220 (“the reconfigurable sensor 220”) that can transition between operating in a depth mode and operating in an intensity mode and that is configured in accordance with various embodiments of the present technology. When operating in depth mode, the reconfigurable sensor 220 can be used to determine distances between (i) objects within an external scene and (ii) the reconfigurable sensor 220 (e.g., the distance L (or L+ focal length fₗₑₙₛ) illustrated in FIG. 1 and described in detail above).

As shown, the reconfigurable sensor 220 includes an array 210 of photomultiplier pixel cells 212. The array 210 can be an example of all or a portion of the pixel array 110 of FIG. 1, or of other arrays configured in accordance with various embodiments of the present technology. In the illustrated example, the array 210 includes four photomultiplier pixel cells 212 positioned in a 2×2 arrangement. In other embodiments, the array 210 can include a different number of photomultiplier pixel cells 212 (e.g., one, two, three, or more than four photomultiplier pixel cells 212) and/or the photomultiplier pixel cells 212 of the array 210 can be positioned in a different arrangement (e.g., 1×4, 4×1, or another arrangement depending on the number of photomultiplier pixel cells 212 employed).

The photomultiplier pixel cells 212 each includes a photosensitive element (e.g., a photosensor), such as a photodiode. As discussed above, each photomultiplier pixel cell 212 is configured to photogenerate an electrical signal (e.g., image charge) in response to incident light from an external scene. In the illustrated embodiment (and in the embodiments described in greater detail below), the photomultiplier pixel cells 212 can each be a single-photon avalanche diode (SPAD) that is sensitive to single-photon strikes (e.g., a single photon incident on the photosensitive element of the photomultiplier pixel cell 212; also referred to herein as a photon event). The photomultiplier pixel cells 212 will therefore be referred to hereinafter as SPADs 212.

As shown in FIG. 2, the reconfigurable sensor 220 further includes a SPAD front-end (FE) 230, a timecode generator 240 (“timer 240”), a D Flip-Flop (DFF) circuit 250, a summation circuit 260, a ripple counter circuit 270, a decoder 255, an SRAM 280, and a memory controller/full adder (MCFA) circuit 290. As illustrated, the SPADs 212 are disposed on a first wafer 224 that is bonded to a second wafer 226 on which the SPAD FE 230, the timer 240, the DFF circuit 250, the summation circuit 260, the ripple counter circuit 270, the decoder 255, the SRAM 280, the MCFA circuit 290, and various multiplexers and/or other logic circuitry are disposed. In some embodiments, the first wafer 224 can be bonded to the second wafer 226 using a hybrid bond. In these and other embodiments, outputs of the SPADs 212 can be coupled to inputs of the SPAD FE 230 via interconnect structures (e.g., vias) and/or the hybrid bond.

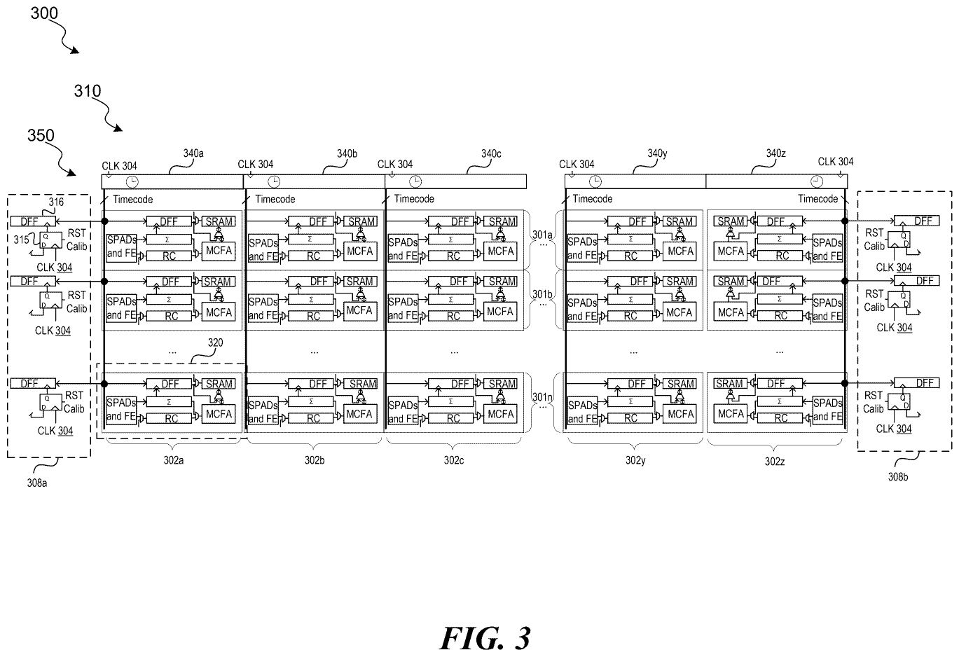

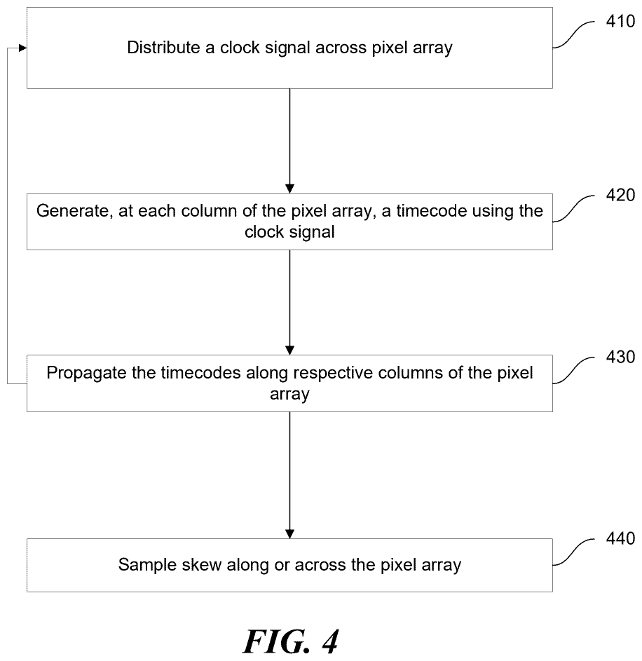

Although the timer 240 is illustrated in FIG. 2 as a sensor-level timer, the timer 240 can be a column-level timer in other embodiments of the present technology, consistent with the description of FIGS. 3 and 4 below. Furthermore, although a single instance of each of the components is shown in FIG. 2, it is appreciated that an image sensor/imaging system can include more than one instance of one or more of the illustrated components. For example, an image sensor/imaging system can include multiple instances of the reconfigurable sensor 220 illustrated in FIG. 2 (e.g., multiple instances of the array 210 that together form a larger array of SPADs 212, with each instance of the array 210 including its own set of (e.g., dedicated) components positioned on the second wafer 226). In some of these embodiments, various circuit blocks can be shared amongst instances of the reconfigurable sensor 220. As a specific example, a single timer (e.g., a single instance of the timer 240) can be shared amongst multiple instances (e.g., two, three, four, or more instances) of the reconfigurable sensor 220, with each instance of the reconfigurable sensor 220 configured to latch timecodes output by the shared timer at times corresponding to when that instance detects a photon event. The reconfigurable sensor 220 illustrated in FIG. 2 is also referred to herein as a “pixel,” a “pixel unit,” and the like. Thus, in embodiments in which an image sensor/imaging system includes multiple instances of the reconfigurable sensor 220, the image sensor/imaging system can be described as including multiple pixels/pixel units/etc. Alternatively, each individual SPAD 212 can be referred to herein as a “pixel,” a “pixel cell,” and the like.

In the illustrated embodiment, inputs of the SPAD FE 230 are coupled to outputs of the SPADs 212 of the array 210 and are configured to receive indications of photon events from the SPADs 212. More specifically, as discussed above, the SPADs 212 are each configured to detect photon events (e.g., individual photons incident on the SPAD 212). Incident photons can include photons from a light or laser pulse emitted by a light source (e.g., a light pulse 105 emitted from the light source 102 of FIG. 1; not shown in FIG. 2) that reflects off of an object in an external scene and thereafter strike photosensitive elements of the SPADs 212. Additionally, or alternatively, incident photons can include photons from the ambient environment that strike photosensitive elements of the SPADs 212.

In depth mode, the reconfigurable sensor 220 can count the number of photon events detected by (e.g., 2×2) groups of SPADs 212. The timer 240 corresponding to a group of SPADs 212 can be reset at a time corresponding to when a laser pulse is emitted into an external scene by a light source (not shown) of an associated imaging system. After the reset, the timer 240 can begin counting while the SPADs 212 of the group are used to detect incident photons. When a photon event is detected by one or more SPADs 212 of the group, the SPAD FE 230 can generate a pulse that is counted by the summation circuit 260 using a synchronous summation technique (SST). In response to receiving the pulse from the SPAD FE 230, the summation circuit 260 can control the DFF circuit 250 to latch the timer value (also referred to herein as a timecode) output by the timer 240 to timestamp detection of the photon event. In turn, the decoder 255 can translate the sampled timecode into an address of a row in the SRAM 280, which corresponds to a bin of a histogram constructed using detected photon events. More specifically, the SRAM 280 can store a histogram of pulse counts, with each row in the SRAM 280 corresponding to a bin of the histogram, and each bin corresponding to a segment of a period of time following emission of the laser pulse by the light source. A current pulse count for the bin addressed by the timecode can be read out from SRAM 280 to the MCFA circuit 290, updated to reflect the detected photon event (e.g., by combining the current pulse count that is read out from the SRAM 280 with the output of the summation circuit 260), and written back into the same row of the SRAM 280 as an updated value. One or more of the SPADs 212 of the group can be reset, such as after the updated pulse count is written into the histogram. Resetting the one or more SPADs 212 can enable the SPAD(s) 212 to detect new/additional photon events. Additional photon events detected by the SPADs 212 can be counted and stored to the SRAM 280 in a manner similar to that described above. The above process can be repeated for each laser pulse emitted into the external scene by the light source, with the ripple counter circuit 270 used to track a number of laser pulses emitted by the light source.

When operated in intensity mode (as opposed to the depth mode described above), the reconfigurable sensor 220 can be used to measure strengths of reflected signals from objects within an external scene, with the measurements indicating how much light emitted from the light source returned to the reconfigurable sensor 220 (e.g., influenced by surface reflectivity of the objects and their angles relative to the laser pulses). The reconfigurable sensor 220 can utilize the SPADs 212 of the array 210 to detect photon events in a manner generally similar to how the SPADs 212 are used to detect photon events in depth mode. In contrast to depth mode, however, each SPAD 212 can be treated individually as opposed to as a group. Thus, the reconfigurable sensor 220 can be configured to accumulate photon events detected by each of the SPADs 212 and store a photon event count for each individual SPAD 212. To this end, in intensity mode, each SPAD 212 can be allocated two or more rows of the SRAM 280: one or more first rows that can be used to store a photon event count for a respective SPAD 212 and one or more second rows that can be used to store a timecode that is usable for absolute intensity calculations when the one or more first rows become saturated during an exposure period.

Furthermore, in intensity mode, the summation circuit 260 can be disabled, and the second output of the SPAD FE 230 can be coupled to the ripple counter circuit 270 such that the ripple counter circuit 270 receives event pulses output by the SPAD FE 230 and tracks photon events on an individual SPAD basis. In some embodiments, the ripple counter circuit 270 can include a plurality of ripple counters and can operate in a pipelined manner. As a specific example, the reconfigurable sensor 220 can include a ripple counter per SPAD 212 (e.g., four ripple counters for the illustrated embodiment, with each SPAD 212 having its own dedicated ripple counter). For example, the SPAD FE 230 can, for each of the SPADs 212, generate a pulse for each detected photon event, which can be counted by a corresponding one of the ripple counters in the ripple counter circuit 270. The ripple counters can employ ping-pong structures, enabling a first portion of the ripple counters to count photon events while a second portion of the ripple counters is used to output photon event counts to the MCFA circuit 290 for storage in an appropriate row of the SRAM 280. Such an approach is expected to reduce the likelihood of photon pileups that may otherwise occur as a result of slower SRAM 280 access times. In intensity mode, the SRAM 280 can be used to store photon event counts and overflow timer values for each SPAD 212. The overflow timer value for each SPAD 212 can correspond to the time value output by the timer 240 when a photon event count for the SPAD 212 has been maxed out/saturated due to memory constraints of a row/bin in the SRAM 280, at which point counting of photon events for all of the SPADs 212 (e.g., in the group and/or across the entire pixel array of an associated imaging system) can be frozen/disabled. For each SPAD 212, the corresponding photon event count and the corresponding overflow timer value can be used to determine intensity values.

Additional details regarding reconfigurable SPAD sensors, including the reconfigurable sensor 220 of FIG. 2, are disclosed in co-filed, co-pending, and co-assigned U.S. patent application Ser. No. 19/071,636, titled “RECONFIGURABLE SINGLE-PHOTON AVALANCHE DIODE SENSORS,” which is incorporated herein by reference in its entirety.

FIG. 3 is a partially schematic, functional block diagram illustrating a time-of-flight (ToF) imaging system 300 (“the system 300”) configured in accordance with various embodiments of the present technology. The system 300 can be an example of the system 100 described above with reference to FIG. 1, or of other systems configured in accordance with various embodiments of the present technology. As shown, the system includes a pixel array 310 including a plurality of reconfigurable SPAD sensors 320 arranged in a plurality of rows 301a, 301b, . . . , and 301n (two or more of which are collectively referred to herein as “rows 301”) and a plurality of columns 302a, 302b, 302c, . . . , 302y, and 302z (two or more of which are collectively referred to herein as “columns 302”). The reconfigurable SPAD sensors 320 can be generally similar to the reconfigurable sensor 220 described above with reference to FIG. 2. Therefore, similar reference numbers are used across FIGS. 2 and 3 to denote identical or at least generally similar components, and a detailed description of the reconfigurable SPAD sensors 320 of FIG. 3 is largely omitted here for the sake of brevity in light of (a) the detailed description provided above with reference to FIG. 2 and (b) the additional details provided in co-filed, co-pending, and co-assigned U.S. patent application Ser. No. 19/071,636, titled “RECONFIGURABLE SINGLE-PHOTON AVALANCHE DIODE SENSORS,” which has been incorporated herein by reference in its entirety above.

As shown, the system 300 of FIG. 3 further includes timing circuitry 350. The timing circuitry 350 includes (i) a plurality of timecode generators 340 (identified individually in FIG. 3 as timecode generators 340a, 340b, 340c, . . . , 340y, and 340z; two or more of which are also collectively referred to herein as “timers 340” or as “counters 340”) and (ii) calibration circuitry 308a and 308b. In the illustrated embodiment, the system 300 employs a column-based TDC architecture in which each of the columns 302 of the pixel array 310 is assigned (or utilizes) one of the timers 340. For example, each of the timers 340 can generate timecode values based on a common clock signal 304. Timecodes generated by a given one of the timers 340 are provided to the reconfigurable SPAD sensors 320 of a corresponding one of the columns 302 (e.g., the timer 340a generates first timecodes based on the clock signal 304 and provides the first timecodes to the reconfigurable SPAD sensors 320 of the column 302a, the timer 340b generates second timecodes based on the clock signal 304 and provides the second timecodes to the reconfigurable SPAD sensors 320 of the column 302b, etc.). Stated another way, the timers 340 can each generate timecodes based at least in part on the clock signal 304, and the generated timecodes can be distributed down respective columns 302 of the pixel array 310. In comparison to pixel-level timing generation, positioning the timers 340 at the column level is expected to (a) free up pixel area, (b) reduce footprint of the reconfigurable SPAD sensors 320, and/or (c) reduce power consumption. Although the timers 340 are shown at the top of the columns of the pixel array 310 in FIG. 3, the timers 340 can be located at other positions in other embodiments of the present technology, such as along the sides and/or bottoms of the columns 302.

In the illustrated embodiment, the common clock signal 304 is distributed to each of the timers 340 and to the calibration circuitry 308a and 308b. In some embodiments, the clock signal 304 may be distributed to the timers 340 and/or to calibration circuitry 308a and/or 308b using an H-tree distribution/clock tree structure, which is expected to reduce, eliminate, or minimize skew in the clock signal 304. The H-tree distribution may help ensure that the clock signal 304 reaches the timers 340 of each the columns 302 of the pixel array 310 and/or the calibration circuitry 308a and/or 308b with minimal timing differences, promoting synchronization across the pixel array 310. In some embodiments, the H-tree distribution of the clock signal 304 may include repeater structures (not shown).

The timers 340 can be configured as phase time-count generators. As a specific example, the timers 340 can each be configured as a 32-phase time-count generator. Continuing with this example, timecodes generated by each of the timers 340 can be five-bit signals, meaning that the timers 340 can each output 32 (e.g., 25) different timecode values or phases. In this example, five bitlines can be used in each of the columns 302 to distribute the five-bit signals from the timers 340 to each of the reconfigurable SPAD sensors 320 in the respective column 302. In other embodiments, timecode values can have another number of bits (e.g., one, two, three, four, or more than five bits), and a corresponding number of bitlines can be used to distribute the timecode values to each of the reconfigurable SPAD sensors 320 of the respective column 302.

In some embodiments, operation of the timers 340 can depend at least in part on a mode of the reconfigurable SPAD sensors 320. For example, while the reconfigurable SPAD sensors 320 of the system 300 are operated in depth mode, the timers 340 can be reset for each new light pulse emitted by a light source (not shown) corresponding to the system 300. After being reset, each of the timers 340 can (a) begin counting according to the clock signal 304 and (b) output timecode values to DFF circuits of the reconfigurable SPAD sensors 320 included in the corresponding one of the columns 302. To this end, the timers 340 can be reset each time a new light pulse is emitted such that the time at which the timers 340 are reset and begins counting is synchronized with the emission of each new light pulse, thereby enabling the reconfigurable sensors 320 to identify and update photon event counts of appropriate bins of the histogram per the discussion of the present technology above.

On the other hand, while the reconfigurable SPAD sensors 320 of the system 300 are operated in intensity mode, the timers 340 can be reset at or before a start of an exposure period, and can begin counting from the beginning of the exposure period in accordance with the clock signal 304. For intensity mode, the clock signal 304 can be slowed in comparison to the clock signal 304 used in depth mode so that the time it takes for the timers 340 to count through its full set of timecodes can span the full duration of the exposure period. Throughout the exposure period, timecodes generated by the timers 340 can be passed to DFF circuits of the reconfigurable SPAD sensors 320 included in the corresponding one of the columns 302. In turn, the timecodes can be output to bidirectional multiplexers of the reconfigurable SPAD sensors 320 per the discussion of the present technology above.

Because timecodes generated by each of the timers 340 are distributed along a corresponding column 302 of the pixel array 310, SPAD sensors 320 of a column 302 that are positioned closer to a corresponding timer 340 may receive the timecodes sooner than SPAD sensors 320 of the column 302 that are positioned further from the corresponding timer 340. In other words, column-level timecode generation and distribution can introduce skew along the columns. Skew across the pixel array 310 may also occur as a result of temperature and/or voltage gradients that extend across two or more of the columns 302. To address this concern, the timing circuitry 350 can include the calibration circuitry 308a and/or 308b to account for (e.g., reduce, minimize, eliminate, factor out, correct) skew.

In particular, the calibration circuitry 308a can include a D flip flop 315 and a DFF circuit 316 for each of the rows 301 of the pixel array 310. Similarly, the calibration circuitry 308b can include a D flip flop 315 and a DFF circuit 316 for each of the rows 301 of the pixel array 310. Each of the D flip flops 315 can be configured to receive the common clock signal 304 and can have a data input terminal D tied to a power supply voltage. Each of the D flip flops 315 can further include an output Q and a reset calibration input configured to receive a reset signal RST Calib. In some embodiments, the reset signal RST Calib can be used to reset the D flip flops 315 each time the timers 340 are reset (e.g., each time a new light pulse is emitted in depth mode and/or at or before a start of an exposure period for intensity mode).

After being reset using the reset signal RST Calib, the calibration circuitry 308a and 308b can be used to sample skew along the columns 302a and 302z, respectively. More specifically, when the clock signal 304 goes high, a voltage at the output Q of each of the D flip flops 315 can correspond to the power supply voltage at the data input terminal D. The voltage at the output Q of each of the D flip flops 315 at this time can be used to clock the corresponding DFF circuit 316 to sample a timecode on the columns 302a and 302z. Samples captured by the DFF circuits 316 can be used to identify and mitigate skew along the columns 302a and 302z. For example, the calibration circuitry 308a can be used to repetitively measure and average skew along the columns 302a and 302z across multiple histogram windows.

As shown in FIG. 3, the calibration circuitry 308a and 308b can be positioned adjacent to the columns 302 of the pixel array 310. As a specific example, the calibration circuitry 308a can be positioned in a first dummy column positioned to the left of the column 302a. Additionally, or alternatively, the calibration circuitry 308b can be positioned in a second dummy column positioned to the right of the column 302z. Positioning the calibration circuitry 308a and the calibration circuitry 308b on opposite sides of the pixel array 310 is expected to facilitate capturing/measuring skew introduced into the system 300 as a result of a temperature and/or voltage gradient that extends across the pixel array 310.

Although shown with the calibration circuitry 308a and 308b on opposite sides of the pixel array 310, the timing circuitry 350 can omit the calibration circuitry 308a or the calibration circuitry 308b in other embodiments of the present technology. Additionally, or alternatively, the timing circuitry 350 can include other calibration circuitry in addition to or in lieu the calibration circuitry 308a and/or 308b, such as calibration circuitry positioned in one or more dummy columns at central locations between two of the columns 302 of the pixel array 310.

FIG. 4 is a flow diagram illustrating a method 400 of operating an imaging system in accordance with various embodiments of the present technology. The imaging system can be the imaging system 100 of FIG. 1, the imaging system 300 of FIG. 3, or another imaging system configured in accordance with various embodiments of the present technology. The imaging system can include column-level timecode distribution, such as to columns of a pixel array of reconfigurable SPAD sensors (e.g., the reconfigurable sensor 220 of FIG. 2, the SPAD sensors 320 of FIG. 3, and/or other SPAD sensors configured in accordance with various embodiments of the present technology). The method 400 is illustrated as a series of steps 410, 420, 430, and 440. All or a subset of one or more of the steps 410, 420, 430, and/or 440 can be executed in accordance with the description above and/or with the description that follows.

At step 410, the method 400 begins by distributing a clock signal across a pixel array. The pixel array can include a plurality of reconfigurable SPAD sensors arranged in a plurality of rows and a plurality of columns. Distributing the clock signal can include distributing the clock signal to a plurality of timers. Each of the plurality of timers can correspond to a respective one of the plurality of columns of the pixel array. Alternatively, each of the plurality of timers can correspond to a respective one of a plurality of rows of the pixel array. Distributing the clock signal can further include distributing the clock signal to calibration circuitry, such as calibration circuitry arranged in one or more dummy columns positioned adjacent to or in a central position within the pixel array. In some embodiments, distributing the clock signal can include distributing the clock signal utilizing an H-tree distribution network or structure, which may include repeater structures.

At step 420, the method 400 continues by generating, at two or more of the plurality of columns of the pixel array, a timecode using the clock signal. In some embodiments, generating the timecode at two or more of the plurality of columns can include generating a timecode at every column of the plurality of columns. Generating the timecode at two or more of the plurality of columns can additionally, or alternatively, include generating the timecodes using two or more timers, each corresponding to one of the two or more columns. Alternatively, in embodiments in which timers correspond to respective rows of the pixel array, the method 400 can continue at step 420 by generating, at two or more of the plurality of rows of the pixel array, a timecode using the clock signal. In some embodiments, each of the generated timecodes is a five-bit signal.

At step 430, the method 400 continues by propagating the generated timecodes along respective columns of the pixel array. Propagating the timecodes along the respective columns can include propagating each of the timecodes to each reconfigurable SPAD sensor of each respective column. Alternatively, in embodiments in which timers correspond to respective rows of the pixel array, the method 400 can continue at step 430 by propagating the generated timecodes along respective rows of the pixel array.

As shown in FIG. 4, the method 400 can return to step 410 (or step 420) to continue distributing the clock signal, generating next timecodes using the clock signal, and propagating the next timecodes along respective columns (or rows) of the pixel array.

At step 440, the method 400 continues by sampling skew along or across the pixel array. In some embodiments, sampling skew along or across the pixel array includes resetting calibration circuitry and/or sampling the skew based on the clock signal. In these and other embodiments, sampling skew includes sampling skew along one or more columns (or one or more rows) of the pixel array. As a specific example, sampling skew can include sampling skew along a first column and along a second column of the pixel array, such as using calibration circuitry arranged in dummy columns that are positioned on opposite sides or edges of the pixel array.

Although the steps 410, 420, 430, and 440 of the method 400 of FIG. 4 are discussed and illustrated in a particular order, the method 400 is not so limited. In other embodiments, all or a subset of one or more of the steps 410, 420, 430, and/or 440 of the method 400 can be performed in a different order. For example, all or a subset of the step 440 can be performed before, during, and/or after all or a subset of any one or more of the other steps 410, 420, and/or 430 of the method 400. Moreover, a person of ordinary skill in the relevant art will recognize that the illustrated method 400 can be altered and still remain within these and other embodiments of the present technology. For example, all or a subset of one or more of the steps 410, 420, 430, and/or 440 of the method 400 illustrated in FIG. 4 can be omitted and/or repeated in some embodiments. As a specific example, the step 440 of the method 400 can be omitted in some embodiments of the present technology.

As another example, the method 400 may include additional steps not shown in FIG. 4. For example, the method 400 can include generating (e.g., using the calibration circuitry) multiple measurements of the skew and/or averages two of more of these measurements, such as across multiple histogram windows (e.g., to determine or track temperature or voltage variations across multiple columns and/or multiple rows of the pixel array). Additionally, or alternatively, the method 400 can include accounting for skew based at least in part on the skew measurements and/or on one or more averages of the skew measurements.

### C. CONCLUSION

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order above, alternative embodiments may perform steps in a different order. Furthermore, the various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where context permits, singular or plural terms may also include the plural or singular term, respectively. In addition, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, an exemplary step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.” Also, the terms “connect” and “couple” are used interchangeably herein and refer to both direct and indirect connections or couplings. For example, where the context permits, element A “connected” or “coupled” to element B can refer (i) to A directly “connected” or directly “coupled” to B and/or (ii) to A indirectly “connected” or indirectly “coupled” to B.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments. Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. An imaging system, comprising:
a pixel array including a plurality of single-photon avalanche diode (SPAD) sensors arranged in a plurality of rows and a plurality of columns; and
a plurality of timers, each timer corresponding to a respective one of the plurality of columns and configured to generate timecodes based on a clock signal,
wherein each SPAD sensor of a given column is configured to receive the timecodes generated by a timer of the plurality of timers that corresponds to the given column.

2. The imaging system of claim 1, further comprising calibration circuitry configured to sample skew along one or more columns of the pixel array.

3. The imaging system of claim 2, further comprising a clock distribution network configured to distribute the clock signal to the plurality of timers and to the calibration circuitry.

4. The imaging system of claim 3, wherein the clock distribution network comprises an H-tree distribution structure.

5. The imaging system of claim 2, wherein the calibration circuitry is arranged in one or more dummy columns positioned adjacent to the pixel array.

6. The imaging system of claim 5, wherein the skew is first skew and the one or more columns is one or more first columns, wherein the calibration circuitry is first calibration circuitry arranged in a first dummy column at a first side of the pixel array, and wherein the imaging system further includes second calibration circuitry (a) configured to sample second skew along one or more second columns of the pixel array and (b) arranged in a second dummy column at a second side of the pixel array opposite the first side.

7. The imaging system of claim 2, wherein the calibration circuitry is arranged in one or more dummy columns positioned in a center of the pixel array.

8. The imaging system of claim 2, wherein:
the calibration circuitry comprises—
a plurality of D flip-flops, and
a plurality of D flip-flop (DFF) circuits; and
each D flip-flop of the plurality of D flip-flops and each DFF circuit of the plurality of DFF circuits corresponds to a respective row of the pixel array.

9. The imaging system of claim 8, wherein:
each D flip-flop of the plurality of D flip-flops (a) is configured to receive the clock signal, (b) has a data input terminal tied to a voltage, and (c) includes an output; and
each DFF circuit of the plurality of DFF circuits (a) is coupled to the output of a corresponding one of the plurality of D flip-flops and (b) is coupled to receive the timecodes generated by a respective one of the plurality of timers corresponding to the one or more columns.

10. The imaging system of claim 9, wherein:
each D flip-flop of the plurality of D flip-flops further includes an input configured to receive a reset signal; and
to sample the skew, the calibration circuitry is configured to:
reset the plurality of D flip-flops using the reset signal, and
sample timecodes on the one or more columns using the plurality of DFF circuits and at a timing corresponding to an edge of the clock signal.

11. The imaging system of claim 1, wherein each of the plurality of SPAD sensors is reconfigurable between a depth mode and an intensity mode.

12. The imaging system of claim 1, further comprising a timecode distribution network configured to propagate the timecodes generated by each timer of the plurality of timers to SPAD sensors of the plurality of SPAD sensors corresponding to the respective one of the plurality of columns.

13. The imaging system of claim 12, wherein each of the timecodes generated by each of the timers is a five-bit signal, and wherein the timecode distribution network includes five bit lines per column of the plurality of columns to distribute the timecodes to the plurality of SPAD sensors.

14. A method of operating an imaging system, the method comprising:
generating, at each of a plurality of timers corresponding to respective columns of a pixel array including a plurality of single-photon avalanche diode (SPAD) sensors arranged in a plurality of rows and a plurality of columns, timecodes using a clock signal; and
propagating, along the respective columns of the pixel array, the generated timecodes to SPAD sensors of the plurality of SPAD sensors.

15. The method of claim 14, further comprising distributing the clock signal to each of the plurality of timers, wherein generating the timecodes includes generating the timecodes based at least in part on the clock signal.

16. The method of claim 15, further comprising distributing the clock signal to calibration circuitry coupled to one or more columns of the plurality of columns.

17. The method of claim 16, wherein distributing the clock signal to each of the plurality of timers and to the calibration circuitry comprises distributing the clock signal using an H-tree distribution network.

18. The method of claim 16, further comprising sampling skew along the one or more columns using the calibration circuitry and based at least in part on the clock signal.

19. The method of claim 18, wherein sampling the skew comprises:
resetting a plurality of D flip-flops of the calibration circuitry; and
sampling timecodes along the one or more columns of the pixel array using a plurality of D flip-flop (DFF) circuits of the calibration circuitry and based at least in part on a timing provided by the clock signal.

20. The method of claim 19, wherein:
sampling the skew includes sampling the timecodes along the one or more columns for each of multiple histogram windows to generate multiple measurements of the skew; and
averaging the multiple measurements across the multiple histogram windows.

21. The method of claim 14, further comprising:
configuring each of the plurality of SPAD sensors in a depth mode of operation; and
resetting the plurality of timers for each new light pulse emitted by a light source associated with the imaging system.

22. The method of claim 14, further comprising:
configuring the plurality of SPAD sensors in an intensity mode of operation; and
resetting the plurality of timers at or before a start of an exposure period.

23. An imaging system comprising:
a pixel array including a plurality of single-photon avalanche diode (SPAD) sensors arranged in a plurality of rows and a plurality of columns;
a plurality of timecode generators, each timecode generator (a) associated with two or more SPAD sensors representing a proper subset of the plurality of SPAD sensors and (b) configured to generate a timecode based at least in part on a clock signal;
a clock distribution network configured to distribute the clock signal to each of the plurality of timecode generators; and
a timecode distribution network configured to propagate the timecodes generated by each timecode generator of the plurality of timecode generators to the two or more SPAD sensors associated with that timecode generator.

24. The imaging system of claim 23, further comprising at least one calibration circuit configured to sample skew based at least in part on the clock signal, wherein the skew represents a timing difference between (a) when a first timecode generated by one of the plurality of timecode generators is received by a first SPAD sensor of the two or more SPAD sensors associated with the one of the plurality of timecode generators and (b) when the first timecode is received by a second SPAD sensor of the two or more SPAD sensors associated with the one of the plurality of timecode generators.
